(19) United States
(12) Patent Application Publication
(10) Pub. No.: US 2011/0307898 A1
(43) Pub. Date: Dec. 15, 2011

(54) METHOD AND APPARATUS FOR EFFICIENTLY DISTRIBUTING HARDWARE RESOURCE REQUESTS TO HARDWARE RESOURCE OFFERS

(75) Inventors: Jan-Gregor Fischer, Wifling/Worth (DE); Steffen Lamparter, Munchen (DE)

(73) Assignee: SIEMENS AKTIENGESELLSCHAFT, Munchen (DE)

(21) Appl. No.: 12/813,115

(22) Filed: Jun. 10, 2010

(51) Int. Cl. G06F 9/50

(52) U.S. Cl. 718/104

(57) ABSTRACT

A method and an apparatus provide for efficiently distributing hardware resource requests to hardware resource offers. Applying the method and apparatus, an allocation of hardware resources is possible in a highly efficient and effective way. Therefore, a system architecture is introduced, which provides components for determining negotiation approaches as well as splitting complex allocation problems into single and independent allocation problems. The method and apparatus find application in a variety of technical domains and especially in the domain of hardware resource allocation as well as agent technology.

### BACKGROUND OF THE INVENTION

### Field of the Invention

The present invention is directed to a method, which allows performing negotiations between hardware requesting devices and hardware offering devices and is especially directed to a method for efficiently distributing hardware resource requests to hardware resource offers. The present invention furthermore provides a respective apparatus for efficient distribution of hardware resource requests to hardware resource offers as well as a computer program product being adapted to perform an execution of the method and a data carrier for storing the computer program product.

Performing control commands requires the availability of computational resources as well as resources as regards storage. However, for providing computational resources a CPU, also referred to as central processing unit, or a GPU, also referred to as graphical processing unit, may be provided. As a variety of control commands is typically performed on devices, one has to identify which control command is performed by which processing unit. Especially in multi core architectures the question arises, which control command is processed by which core of a processing unit. A hardware requesting device can therefore specify which hardware resources are required. A resource offering device specifies, which hardware resources are available or offered and finally the hardware requests are matched with the specified hardware resource offers. Commonly known methods suggest a variety of hardware allocation techniques for assigning hardware requests to hardware offers.

Concerning the allocation of hardware resources constraints are posed as regards efficiency and effectiveness of applied approaches. A negotiation mechanism is required to be performed with a minimum of hardware resources and must not require excessive additional computation time. Typically the allocation processes require additional CPU time as well as additional storage as regards the computation of the control commands themselves.

Commonly known methods apply market mechanisms such as auctions and negotiations for assigning goods to interested parties, for instance a software agent. Examples for such commonly known methods are trading platforms, stock exchanges and distribution of UMTS licenses. The market mechanisms find application in a variety of technical domains such as management of energy networks, routing of IP packages over the internet, allocation of computation resources, for instance in grid or cloud systems. Grid technologies and cloud computing enable a dynamic outsourcing of computer resources and services, thus allowing enterprises to cut down on hardware and software expenses.

For providing functionality, for instance controlling a machine, Web Services are applied, which contain control commands, which are typically geographically distributed over several hardware devices. Web Services are a technology for enabling distributed computing infrastructures for collaboration. Although in theory, users could utilize Web Services from multiple locations, this potential is rarely exploited in practice. This seeming contradiction is caused by the significant barriers that arise when organizational boundaries are crossed. Overcoming these barriers requires that Web Services can be reliably discovered, acquired, and managed.

Commonly known service discovery mechanisms for Web Services use matchmaking algorithms, which rely on attribute-based matching functions. However, these algorithms fall short of capturing the semantics required for automatic service discovery. Web Services can be specified by a formal and unambiguous description of their capabilities. Instead of syntactic matching algorithms, services can be semantically matched using concepts and relations formalized by use of ontologies or further technical specifications.

Commonly known methods using a direct application of semantic matchmaking mechanisms for allocating Web Services have several drawbacks, of which a selection is described in the following: firstly, these algorithms do not guarantee that those requesters will receive the supplied services who value them most. Secondly, they ignore the fact that users will only offer their services if they are adequately compensated. Compensation requires determining how the offered services are allocated among potential requesters and how the prices for the services are set. Thirdly, semantics based matchmaking algorithms are typically computational demanding and thus not adequate for large-scaled negotiations. However, these aspects are crucial for implementing efficient Web Service infrastructures.

Commonly known methods furthermore apply employing specific mechanisms for the allocation of Web Services. Markets can be an effective institution to allocate resources. This is achieved by the interplay of demand and supply and due to the information feedback inherent to the system. As such, the application of specific mechanisms for the service discovery is deemed promising. However, applying mechanisms according to commonly known methods for handling Web Services may lead to inefficient outcomes as these mechanisms allocate on base of syntactical descriptions.

Commonly known methods are typically not able to handle complex hardware resource requests and complex hardware resource offers, as they may contain several attributes. Furthermore, commonly known methods are not able to negotiate over complex bundles of hardware resource offers and hardware resource requests. Furthermore, a suitable approach for allocating hardware must be performed efficiently as regards the consumption of hardware resources. An allocation mechanism is furthermore required to operate dynamically under consideration of the complexity of current negotiations.

### SUMMARY OF THE INVENTION

It is accordingly an object of the invention to provide a method and an apparatus for efficiently distributing hardware resource requests to hardware resource offers which overcome the above-mentioned disadvantages of the prior art methods and devices of this general type, which allows an efficient hardware allocation and especially to provide a method for efficiently distributing hardware resource requests to hardware resource offers.

Therefore, a method for efficiently distributing hardware resource requests to hardware resource offers is provided. The method includes selecting stored allocation information in dependence on a provided selection metric. The stored allocation information provides an allocation mechanism for allocating at least one hardware resource request to at least one hardware resource offer. At least a selection of hardware resource requests is allocated to at least a selection of hardware resource offers in dependence on the selected allocation information.

A hardware resource request as well as a hardware resource offer can be issued by a device or a machine. The device or machine may be implemented by an agent. An agent is a physical device, a virtual device and/or a set of control commands. A virtual device describes physical hardware entities, which are simulated, emulated and/or virtualized. Hence, an agent may be formed by a device, which is arranged along an assembly line and requests a specific service from a further device, being also arranged along the same assembly line. An agent may also be a client and request at least one hardware resource and/or a service from a server. It may therefore be of advantage that the agent is formed by a module. A module contains at least one control command and be configured to specify at least one hardware resource request. The agent may provide a data file, specifying at least one hardware resource request, which may again contain several single further hardware resource requests and/or several compound hardware resource requests.

A compound hardware resource request can for instance describe that for performing a computation a certain computational power and storage space is required. A single hardware resource request can specify that only computational power is requested. A hardware resource request may also contain a specification of a demanded amount of energy. Hence, it is possible that a hardware resource request is implicitly provided by consuming a certain amount of energy. As regards this example, a hardware resource requesting device can be formed by a household and a hardware resource offering device can be formed by a power plant. In a further scenario several households specify several hardware resource requests, namely a specific amount of energy, and several hardware resource offering devices specify several hardware resource offers.

A hardware resource offer contains analogue information as regards the hardware resource requests. A hardware resource offer may contain information as regards provided services and functionality. It is of advantage to specify a certain time slot or duration describing the availability of the hardware resource offer. It is therefore possible that a hardware resource offer specifies an identifier of a specific service along with a time stamp indicating from which point of time the offered service is available. After specifying at least one hardware resource request at least one hardware resource offer is specified. The hardware resource request can be assigned to the specified hardware resource offer. Distributing may furthermore contain several sub steps such as an allocation or assignment of hardware resource requests to hardware resource offers.

For allocating hardware resource requests to hardware resource offers location information is selected. The allocation information provides an allocation mechanism for allocating at least one hardware resource request to at least one hardware resource offer. Hence, the allocation information generally provides a hint how to distribute the hardware resource requests to the hardware resource offers. The distribution may be performed by market mechanisms, such as auctioning and/or negotiation processes. It is therefore possible that the stored allocation information provides static information specifying a distribution of hardware resource requests to hardware resource offers or that the stored allocation information provides control commands for dynamically negotiating between hardware resource requesting devices and hardware resource offering devices. The stored allocation information may for instance describe a specific auctioning approach.

For selecting stored allocation information several allocation information data sets are provided, for instance by a database. It is therefore possible that several allocation information data sets are a priori to performing the step of selecting stored allocation information is defined and stored in the database. Selecting itself is accomplished as a function of a provided selection metric. The selection metric defines constraints, which serve for evaluating posed hardware resource requests and/or posed hardware resource offers. Hence, it is possible to select stored allocation information as a function of currently provided hardware resource requests and currently provided hardware resource offers. The selection metric may for instance define several hardware resource requests as well as hardware resource offers and may furthermore specify which stored allocation information is to be selected in case these hardware resource requests and specific hardware resource offers are present.

The selected allocation information serves as a mechanism for allocating at least a selection of hardware resource requests to at least a selection of hardware resource offers. Hence, the selected allocation information is applied on a first selection of hardware resource offers and furthermore on a second selection of hardware resource requests. It is of advantage to select specific hardware resource requests and furthermore select specific hardware resource offers, which are then mutually allocated. Hence, not all present hardware resource requests are distributed to the present hardware resource offers, but one can divide the set of present hardware resource requests divide the present set of hardware resource offers into further subsets.

It may be of advantage that the subsets are mutually disjoint. As the step of allocating at least a selection of hardware resource requests to at least a selection of hardware resource offers may be performed iteratively all subsets of the resource requests and hardware resource offers can be allocated. Hence, the problem of distributing hardware resource requests to hardware resource offers is broken down into several sub problems by only distributing a selection of hardware resource requests to at least a selection of hardware resource offers. It is furthermore of advantage that the subsets can be treated independently and can therefore be computed by several, for instance independent, computation devices. The computation of allocation of at least a selection of hardware resource requests to at least a selection of hardware resource offers can therefore be performed iteratively, which means it can be performed several times under consideration of several selections of hardware resource requests and several selections of hardware resource offers and furthermore the step of allocating can be performed several times in parallel.

In an embodiment of the method for efficiently distributing hardware resource requests to hardware resource offers according to the present invention the step of allocating at least a selection of hardware resource requests to at least a selection of hardware resource offers is performed iteratively, wherein the selection of resource requests and the selection of hardware resource offers is adapted in each iteration.

This has the advantage that the several selections of hardware resource offers as well as several selections of hardware resource requests can be formed and distributed in independent iterations.

In yet a further embodiment of the method for efficiently distributing hardware resource requests to hardware resource offers according to the present invention a first selection of hardware resource requests is disjoint from a second, adapted selection of hardware resource requests and a first selection of hardware resource offers is disjoint from a second, adapted selection of hardware resource offers.

This has the advantage that selections of hardware resource requests and selection of hardware resource offers can be treated independently and can furthermore be handled in parallel.

In yet a further embodiment of the method for efficiently distributing hardware resource requests to hardware resource offers according to the present invention the selection of hardware resource requests and the selection of hardware resource offers is formed as function of stored selection information.

This has the advantage that any of the formed selections can be generated according to a specific metric and/or constraint as regards semantics of respective requests and respective offers.

In yet a further embodiment of the method for efficiently distributing hardware resource requests to hardware resource offers according to the present invention the stored selection information is provided by at least one of a group of description techniques, the group containing: a formal model, a semi-formal model, an ontology, a set of rules and a specification.

This has the advantage that the stored selection information can be described by additional meta information, which is provided in accessible data formats.

In yet a further embodiment of the method for efficiently distributing hardware resource requests to hardware resource offers according to the present invention the stored selection information is provided by a reasoning device as a function of the at least one description technique.

This has the advantage that the provided description techniques can be evaluated by already implemented reasoners.

In yet a further embodiment of the method for efficiently distributing hardware resource requests to hardware resource offers according to the present invention a hardware resource is provided by at least one of a group of technical devices. The group contains: a computer, a calculation device, a storage device, a network device, a machine, a robot, a power plant and a power source.

This has the advantage that several types of hardware resources can be applied for issuing hardware resource requests as well as hardware resource offers.

In yet a further embodiment of the method for efficiently distributing hardware resource requests to hardware resource offers according to the present invention the hardware resource requests are formed by at least one of a group of inquiries. The group contains: an inquiry for computation time, an inquiry for energy, an inquiry for storage, an inquiry for providing a functionality, a time stamp, a time slot and a priority information.

This has the advantage that the introduced method for efficiently distributing hardware resource requests to hardware resource offers can be applied in a variety of technical domains.

In yet a further embodiment of the method for efficiently distributing hardware resource requests to hardware resource offers according to the present invention the allocation information contains calculation steps for assigning at least one hardware resource request to at least one hardware resource offer.

This has the advantage that the allocation information can contain several steps, which allow a dynamic distribution of hardware resource requests to hardware resource offers.

In yet a further embodiment of the method for efficiently distributing hardware resource requests to hardware resource offers according to the present invention the allocation information specifies an auctioning mechanism.

This has the advantage that the allocation information provides a measure for dynamically negotiating an allocation of active requests to respective offers.

In yet a further embodiment of the method for efficiently distributing hardware resource requests to hardware resource offers according to the present invention the selection metric assigns at least one stored allocation information to at least one of a group of resource information items. The group contains: an expected hardware resource request and an expected hardware resource offer.

This has the advantage that the selection metric specifies, which allocation information is selected in case specific hardware resource requests and specific hardware resource offers are issued.

In yet a further embodiment of the method for efficiently distributing hardware resource requests to hardware resource offers according to the present invention at least one of a group of method steps is performed by a virtual hardware device. The group includes selecting the stored allocation information and allocating at least a selection of hardware resource requests to at least a selection of hardware resource offers.

This has the advantage that hardware resources can be provided by virtual hardware devices.

Furthermore an apparatus for efficient distribution of hardware resource requests to hardware resource offers is provided. The apparatus contains a selection unit for selecting stored allocation information in dependence on a provided selection metric. The stored allocation information provides an allocation mechanism for allocating at least one hardware resource request to at least one hardware resource offer; and an allocation unit for allocating at least a selection of hardware resource requests to at least a selection of hardware resource offers as a function of the selected allocation information.

Furthermore a computer program product being adapted to perform an execution of the method as well as a data carrier for storing the computer program product is provided.

Other features which are considered as characteristic for the invention are set forth in the appended claims.

Although the invention is illustrated and described herein as embodied in a method and an apparatus for efficiently distributing hardware resource requests to hardware resource offers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram of a method for efficiently distributing hardware resource requests to hardware resource offers according to an embodiment of the present invention;

FIG. 2 is a detailed flow diagram of a method for efficiently distributing the hardware resource requests to the hardware resource offers according to an embodiment of the present invention;

FIG. 3 is a block diagram of an apparatus for efficient distribution of the hardware resource requests to the hardware resource offers according to an embodiment of the present invention;

FIG. 4 is a detailed block diagram of an apparatus for efficient distribution of the hardware resource requests to the hardware resource offers according to an embodiment of the present invention; and

FIG. 5 is a detailed block diagram of an apparatus for efficient distribution of the hardware resource requests to the hardware resource offers according to an embodiment of the present invention.

### DESCRIPTION OF THE INVENTION

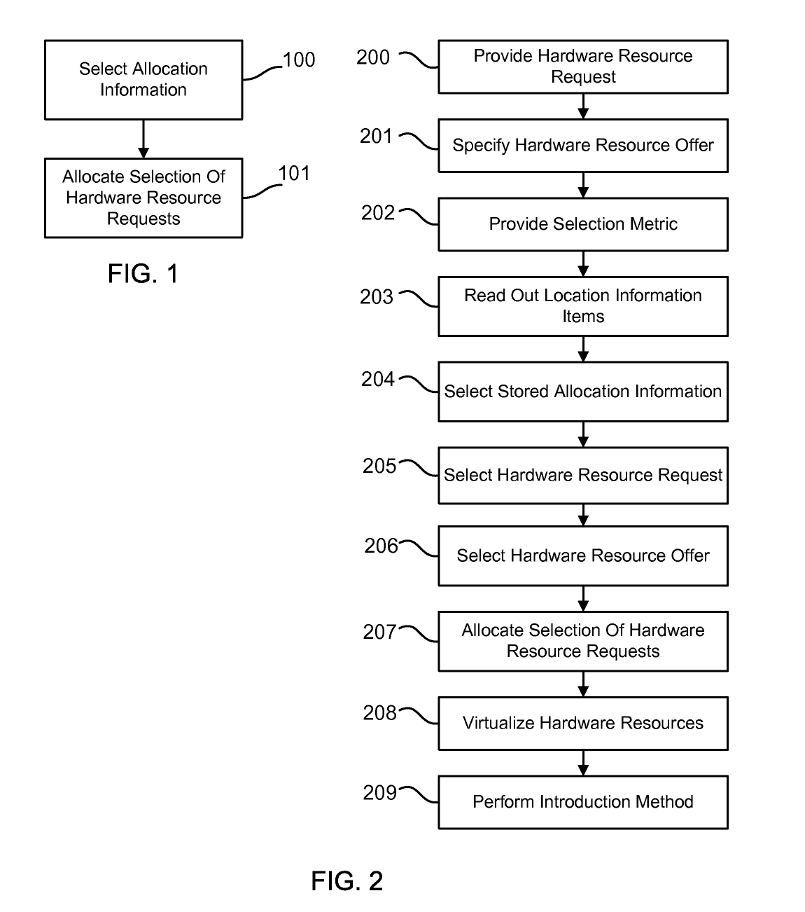

Referring now to the figures of the drawing in detail and first, particularly, to FIG. 1 thereof, there is shown a flow diagram of a method for efficiently distributing hardware resource requests to hardware resource offers.

In step 100 stored allocation information is selected in dependence on a provided selection metric. The stored allocation information provides an allocation mechanism for allocating at least one hardware resource request to at least one hardware resource offer.

In step 101 at least a selection of hardware resource requests is allocated to at least a selection of hardware resource offers in dependence on the selected allocation information.

The afore-mentioned steps may be performed iteratively and/or in a different order and may contain further sub steps.

FIG. 2 shows a detailed flow diagram of a method for efficiently distributing hardware resource requests to hardware resource offers.

In a preliminary step 200 at least one hardware resource request is provided. Providing at least one hardware resource request may be performed by measuring hardware requirements such as a specific computation time, computation complexity, storage requirements and/or energy requirements. Hence, in the first step 200 a signal describing at least one hardware resource request is generated. It may further be possible to derive the hardware resource request from a specification of a hardware resource requesting device. The product specification may therefore be analyzed for specifying an energy consumption being required for providing a functionality. In further sub steps the resource request may be refined, for instance by defining additional attributes describing further features of the hardware resource requests.

In a subsequent step 201 at least one hardware resource offer is specified. This may be accomplished in an analogue way as regards the provision of the hardware resource request in step 200. Hence, in step 201a hardware resource offer can be measured. In case the hardware resource offering device is a power plant, one can measure in method step 201 the amount of energy being provided by the power plant. The hardware resource offer can also be derived from a specification of the hardware resource offering device. It may be of advantage to provide the hardware resource request in step 200 in a data format conforming to a data format being used for providing the hardware resource offer in step 201. Hence, the hardware resource request and the hardware resource offer can be easily matched.

It may be of advantage to perform several iterations of step 200 and step 201 providing a variety of hardware resource requests and a variety of hardware resource offers.

Furthermore a selection metric is provided in step 202. The selection metric contains information, which specifies which allocation information out of several location information items is selected in case specific hardware resource requests as well as specific hardware resource offers occur. The selection metric may hence describe that in case hardware resource requests as regards CPU time are issued and that hardware resource offers containing both, CPU time and storage space, a specific mechanism is to be selected. Hence, a negotiation approach is described in context of occurring hardware resource requests and occurring hardware resource offers by the selection metric.

As the selection metric is provided in step 202 several location information items may be read out from a database in step 203 of which one allocation information is selected in a subsequent step 204.

The allocation information items may be stored in a database, which provides meta information along with several allocation information items. The database may contain at least one allocation information with additional data such as author and a time stamp indication the creation date of the allocation information. After at least one stored allocation information is read out in step 203 one is selected in step 204, for instance by application of the provided selection metric in step 202.

In further steps 205 and 206 a selection of the provided hardware resource requests of step 200 as well as a selection of the provided hardware resource offers of step 201 is created. Hence, step 205 describes the step of selecting at least one hardware resource request and step 206 describes the step of selecting at least one hardware resource offer.

Steps 205 and 206 may be performed iteratively, which results in a provision of several selections of hardware resource requests as well as several selections of hardware resource offers. It may be of advantage to provide disjoint selections of hardware resource requests as well as disjoint selections of hardware resource offers. Hence, the respective requests as well as the respective offers can be allocated independently.

In a subsequent step 207 an allocation of the selection of hardware resource requests as being provided in step 205 with the selection of the hardware resource offers as being provided in step 206 is performed. Step 207 may be accomplished by applying the selected allocation information of step 204.

In further optional steps 208 and 209 hardware resources are virtualized, which may be performed in step 208 and the introduced method for efficiently distributing hardware resource requests to hardware resource offers is performed on the virtualized hardware in step 209. Hence, a deployment, for instance of an auction or generally a negotiation, is performed in step 208, while the deployment is executed in the subsequent step 209. Hence, step 209 distributes hardware resource requests to hardware resource offers according to the previously determined parameters of step 200 to step 208.

The afore-mentioned steps may be performed iteratively and/or in a different order and may contain further sub steps.

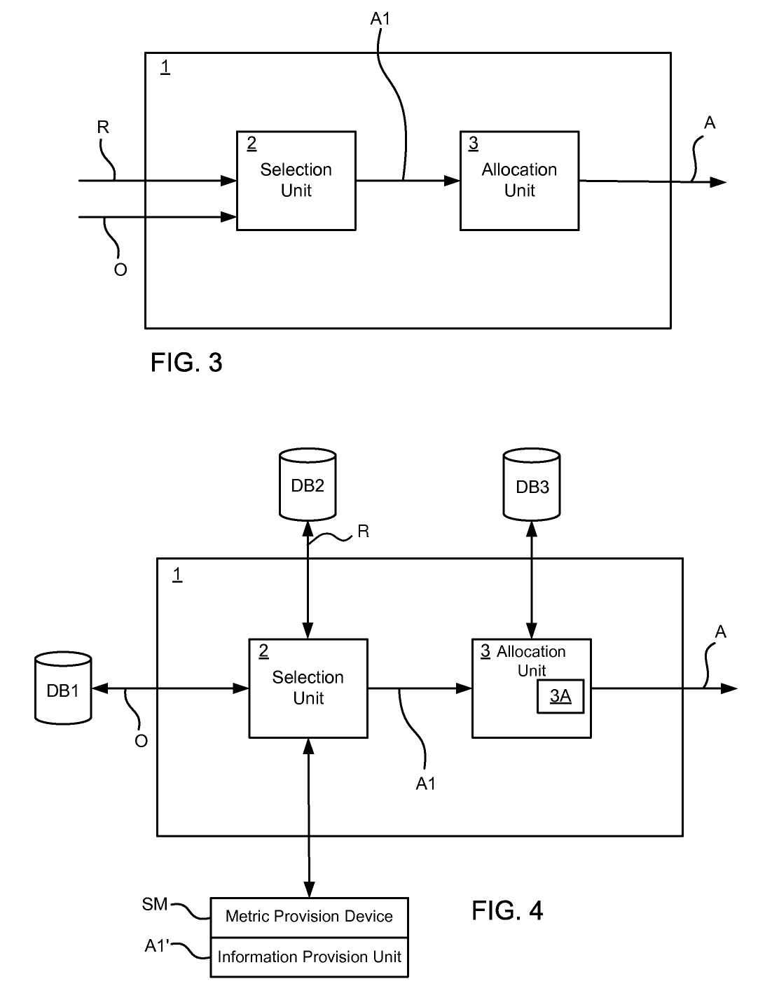

FIG. 3 describes a block diagram of an apparatus 1 for efficient distribution of hardware resource requests R to hardware resource offers O.

A selection unit 2 for selecting stored allocation information AI with a function of a provided selection metric, wherein the stored allocation information AI provides an allocation mechanism for allocating at least one hardware resource request R to at least one hardware resource offer O.

An allocation unit 3 for allocating at least a selection of hardware resource requests R to at least a selection of hardware resource offers O as a function of the selected allocation information AI. The allocation A may be output.

FIG. 4 shows a detailed block diagram of an apparatus 1 for efficient distribution of hardware resource requests R to hardware resource offers O and differs from the apparatus 1 as shown in FIG. 3.

In the present embodiment the apparatus 1 for efficient distribution of hardware resource requests R to hardware resource offers O communicates with a variety of databases, for instance DB1, DB2 and DB3. The database DB1 is configured to provide hardware resource offers O, the database DB2 is configured to provide hardware resource requests R and the database DB3 is configured to provide at least one selection information. The databases DB1, DB2 and DB3 may be formed by at least one database system and may be accessed via a network. The network may contain network typical devices, such as servers, routers as well as further network components. It is also possible to implement the databases DB1, DB2 and DB3 as at least one common database.

For provision of a selection metric the selection unit 2 communicates with a selection metric provision device. The selection metric provision device may furthermore be configured to implement logics for selecting at least one allocation information out of a variety of allocation information items. The allocation information items may be generated by a further location information provision unit AI; it is of advantage to implement the selection metric provision device SM as well as the allocation information generation device AI′ as a database system. The data base system contains the database itself, which be formed by the allocation information provision device AI′, and the database system furthermore contains a logic operating on the stored data sets, for instance implemented by the selection metric provision device SM. It is also possible to implement the database system as a component formed in the selection unit.

In the present embodiment of the apparatus 1 for efficient distribution of hardware resource requests R to hardware resource offers O the allocation unit 3 contains a selection information provision device 3A. The selection information provision device 3A is configured to separate received hardware resource requests R and hardware resource offers O into sets, for instance disjoint sets.

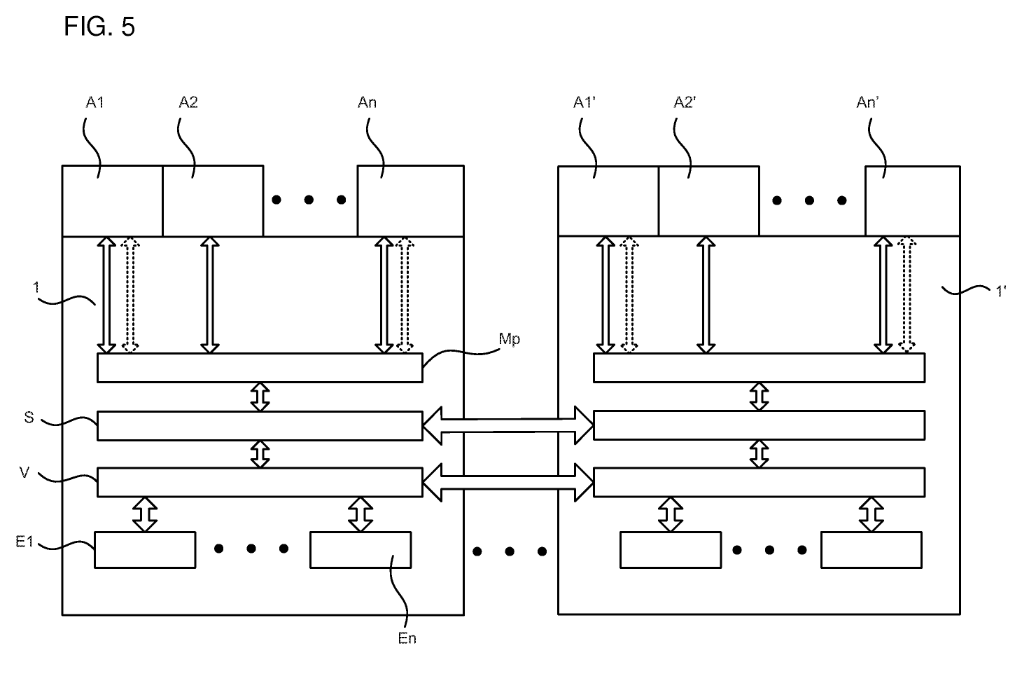

FIG. 5 shows a detailed diagram of two apparatus 1, 1′ for efficient distribution of hardware resource requests R to hardware resource offers O, communicating with each other, for instance for load balancing.

In the present embodiment the apparatus 1 contains several agents A1, A2, . . . , An, a mechanism provider MP, a splitter S, a virtualizer V as well as executing units E1, E2, . . . , En.

In the present embodiment the apparatus 1 provides a scalable market platform, for automatically determining the right solution algorithm, the solution algorithm being divided into single, independent problems and distributing the problems towards available hardware resources. This solution is based on a market virtualization layer, which chooses the market mechanism in a fashion being transparent to a user and distributing the market mechanism to different executing units E1, E2, . . . , En for their computation.

The mechanism provider MP determines the simplest, which means the most efficient and effective, mechanism for the incoming hardware resource requests and hardware resource offers. For instance, a combinatory auctioning approach is used only in case combined hardware resource offers O are present, which may also be referred to as pay as you go approach. Which mechanism is used for which problem can be defined by declarative rules or by control commands being implemented in the mechanism provider MP in a hardwired fashion

The splitter S splits the marked mechanisms in single, independent and hence independently and parallel computational problems, which are then distributed by a virtualizing component, for instance the virtualizer V, on existing hardware resources. Hardware resources may be internally or externally arranged as regards the apparatus 1. By a semantic analysis of hardware resource offers O one can grant that no possible transactions are lost by splitting. It may be of advantage to apply a reasoner for deriving further logical assumptions.

The virtualizer V performs an optimal deployment of the auction or negotiation approach on existing, external or external, resources. In case load complexity varies a dynamic adaptation of deployment is performed. The market mechanisms can be relocated on existing hardware resources, for instance dynamically and at one time.

Execution devices E1, E2, . . . , En compute a market instance by the assigned resources. It may be of advantage to provide a further linear program and determine an optimal solution as regards efficiency and effectiveness.

The apparatus 1 and the apparatus 1′ may communicate with each other, for instance for load balancing, which is in the present figure indicated by two errors connecting a first splitter S and a second splitter S′ as well as a first virtualizer V and a second virtualizer V′.

Generally the mechanism provider MP, the splitter S as well as the virtualizer V along with further components, such as agents A1, A2, . . . , An as well as the execution devices E1, E2, . . . , En implement a market virtualization layer. A market is the present embodiment formed by available hardware resource requests R and hardware resource offers O. The market virtualization layer hence performs an efficient determination of location information, a dynamic resource allocation and a dynamic selection of the market mechanism. This layer combines components for an adapted market mechanism selection, a market splitting form further parallelization and simplification of the problem in a fashion being transparent for the user and furthermore for resource virtualization. Hence, a maximum of performance and scalability is available for determining an allocation and prices on the market.

Therefore, the mechanism provider MP chooses the most effective market form, being required for the current hardware resource offers, which means that simple problems with a low complexity are solved by simple approaches with a low complexity and furthermore that combinatorial problems are solved by respectively complex approaches. Hence, a minimum of computation resources are required.

The splitter S splits problems into less complex, independent problems and hence for reducing the overall complexity of the allocation problem. Furthermore a parallel computation of the market approach is made possible by the introduced method.

The single market problem is distributed by the virtualizer V on the existing internal and external resource. As the allocation can be dynamically adapted, the market platform can be adapted as well as a function of currently incoming hardware resource offers.

1. A method for efficiently distributing hardware resource requests to hardware resource offers, which comprises the steps of:
selecting stored allocation information in dependence on a provided selection metric, the stored allocation information provides an allocation mechanism for allocating at least one hardware resource request to at least one hardware resource offer; and
allocating at least a selection of hardware resource requests to at least a selection of hardware resource offers in dependence on the allocation information selected.

2. The method according to claim 1, which further comprises:
performing the step of allocating at least the selection of hardware resource requests to at least the selection of hardware resource offers iteratively; and
adapting the selection of hardware resource requests and the selection of hardware resource offers in each iteration.

3. The method according to claim 2, wherein a first selection of hardware resource requests is disjoint from a second, adapted selection of hardware resource requests and a first selection of hardware resource offers is disjoint from a second, adapted selection of hardware resource offers.

4. The method according to claim 1, which further comprises forming the selection of hardware resource requests and the selection of hardware resource offers in dependence on stored selection information.

5. The method according to claim 4, wherein the stored selection information is provided by at least one of a group of description techniques, the group of description techniques containing a formal model, a semi-formal model, an ontology, a set of rules, and a specification.

6. The method according to claim 5, which further comprises providing the stored selection information via a reasoning device in dependence on at least one description technique.

7. The method according to claim 1, wherein a hardware resource is provided by at least one of a group of technical devices, the group of technical devices containing a computer, a calculation device, a storage device, a network device, a machine, a robot, a power plant and a power source.

8. The method according to claim 1, wherein the hardware resource requests are formed by at least one of a group of inquiries, the group of inquiries containing an inquiry for computation time, an inquiry for energy, an inquiry for storage, an inquiry for providing a functionality, a time stamp, a time slot and priority information.

9. The method according to claim 1, wherein the stored allocation information contains calculation steps for assigning at least one hardware resource request to at least one hardware resource offer.

10. The method according to claim 1, wherein the stored allocation information specifies an auctioning mechanism.

11. The method according to claim 1, wherein the provided selection metric assigns at least one stored allocation information to at least one of a group of resource information items containing an expected hardware resource request and an expected hardware resource offer.

12. The method according to claim 1, which further comprises:
performing the following steps via a virtual hardware device:
selecting the stored allocation information; and
allocating at least the selection of hardware resource requests to at least the selection of hardware resource offers.

13. An apparatus for efficient distribution of hardware resource requests to hardware resource offers, the apparatus comprising:
a selection unit for selecting stored allocation information in dependence on a provided selection metric, the stored allocation information provides an allocation mechanism for allocating at least one hardware resource request to at least one hardware resource offer; and
an allocation unit for allocating at least a selection of hardware resource requests to at least a selection of hardware resource offers in dependence on the allocation information selected.

14. A computer-readable medium having computer-executable instructions for performing a method comprising:
selecting stored allocation information in dependence on a provided selection metric, the stored allocation information provides an allocation mechanism for allocating at least one hardware resource request to at least one hardware resource offer; and
allocating at least a selection of hardware resource requests to at least a selection of hardware resource offers in dependence on the allocation information selected.

15. A computer program product having computer-executable instructions for performing a method comprising:
selecting stored allocation information in dependence on a provided selection metric, the stored allocation information provides an allocation mechanism for allocating at least one hardware resource request to at least one hardware resource offer; and
allocating at least a selection of hardware resource requests to at least a selection of hardware resource offers in dependence on the allocation information selected.
